(19) United States
(12) Patent Application Publication
(10) Pub. No.: US 2014/0196553 A1
(43) Pub. Date: Jul. 17, 2014

(54) ADJUSTABLE OBJECT

(71) Applicant: Johan RINMAN, Jonkoping (SE)

(72) Inventor: Johan RINMAN, Jonkoping (SE)

(21) Appl. No.: 13/741,905

(22) Filed: Jan. 15, 2013

(51) Int. Cl. F16H 19/06

(52) U.S. Cl. CPC F16H 19/06
USPC 74/89.2

(57) ABSTRACT

An actuator for adjusting the length of an extensible member, the actuator comprising: a driving mechanism; a rotary member arranged to be driven about its axis by the driving mechanism selectively in a first direction and a second direction; and an elongate flexible member supported by a constraint means for transmitting force from the actuator to the extensible member in order to adjust the length thereof; the elongate flexible member passing around and being engaged with the rotary member such that rotation of the rotary member in the first direction causes the elongate flexible member to be extended and rotation in the second direction causes the elongate flexible member to be retracted.

### FIELD OF THE INVENTION

The present invention relates to an apparatus for changing the length of a member, and in particular, but not exclusively, to an apparatus for adjusting the length of a support for an object in order to adjust the height thereof above a surface. For example, the invention may be used to provide a height-adjustable table.

### BACKGROUND OF THE INVENTION

It is often desirable to adjust the height of an object and in particular furniture such as tables, chairs, beds. For example, the ideal height of a table may depend on what it is being used for at a given time, or the height of the person using it. As these factors may change over time, it is desirable to provide a table where the height of the tabletop above the surface on which the table stands may be adjusted.

Additionally, there is a demand for devices which can be height-adjusted during use. For example, it may be desirable to provide a chair which can be raised as the user is standing up.

Furthermore, there are numerous applications for supports, mounts, display stands, etc. where it is desired to support something above the ground, whilst being able to adjust its height.

The awareness of the importance of good ergonomics in relation to furniture, tools and other products is increasing and as a result it is perceived that the desire is increasing for apparatus of many kinds which can be adjusted to suit the user.

It is, of course, well known to provide such objects with one or more legs whose length may be adjusted in order to vary the height of the object. However, there remains the need to provide a practical and convenient system for the user to adjust the length of the legs at will.

GB 766805 discloses a vertically adjustable bed table. The table comprises a tabletop supported on an inverted U-shaped tubular frame member, the open ends of which each telescopically engage a rod. Within the U-shaped tubular frame members are a pair of flexible members which each extend from their inner ends, near the middle of the U-shaped tubular frame member to their outer ends which abut the two rods. When endwise pressure is applied to the inner end of both the flexible members, they each move within the U-shaped tubular member thereby transmitting force to the rods causing them to telescopically slide out of the U-shaped tubular frame and thereby causing the table top to rise.

In order to apply endwise pressure to the inner ends of the flexible members a screw is provided, one half of which is left hand threaded and the other half of which is right hand threaded. The screw is parallel and adjacent the top of the U-shaped tubular frame. The screw is provided with two nuts which have lugs which each engage with the inner end of one of the flexible members through slots provided in the tubular member. The screw extends laterally to one side of the table top and is provided with a handle for winding the screw.

Upon winding the screw the nuts are caused to move from a position midway of the tubular member outwardly to apply endwise pressure to the inner end of the two flexible members which causes the rods to telescopically slide out of the inverted U-shaped tubular member and thus causes the tabletop to rise. Rotation of the screw in the opposite direction moves the nuts back toward the center which removes the pressure from the end of the flexible members. As a result of the weight of the table, the tabletop will lower.

Although this is an effective system, the present inventors have recognized that it is subject to a number of drawbacks, not least that the actuating mechanism takes up a large amount of space and that the degree of extension possible is determined by its linear dimensions. Thus, in GB 766805 the maximum height adjustment is dependent on the length of screw that the nuts travel along, which in turn depends on the size of the table top, or other surface This may cause a problem if the surface to be raised is relatively small, for example a chair, or the maximum required height adjustment is relatively large.

### SUMMARY OF THE INVENTION

According to a first aspect of the present invention there is provided an actuator for adjusting the length of an extensible member, the actuator comprising: a driving mechanism; a rotary member arranged to be driven about its axis by the driving mechanism selectively in a first direction and a second direction; and an elongate flexible member supported by a constraint means for transmitting force from the actuator to the extensible member in order to adjust the length thereof; the elongate flexible member passing around and being engaged with the rotary member such that rotation of the rotary member in the first direction causes the elongate flexible member to be extended and rotation in the second direction causes the elongate flexible member to be retracted.

The invention extends to a corresponding method and so, viewed from a second aspect, the invention provides a method of adjusting the length of an extensible member comprising: providing an actuator comprising a driving mechanism, a rotary member arranged to be driven about its axis by the driving mechanism selectively in a first direction and a second direction, and an elongate flexible member supported by a constraint means for transmitting force from the actuator to the extensible member in order to adjust the length thereof, the elongate flexible member passing around and being engaged with the rotary member at its proximal end and being engaged with the extensible member at its distal end; and driving the rotary member of the actuator in order to extend and/or retract the elongate flexible member to thereby adjust the length of the extensible member.

By avoiding the use of a linear system such as the screw in GB 766805, the actuator of the present invention may be far more compact and is capable of providing a much greater length adjustment for a given maximum linear dimension.

It will be appreciated that by extending the elongate flexible member, a force for extending the extensible member may be transmitted from the actuator to that member and by retracting the elongate flexible member, a force for retracting the extensible member may be provided. The elongate flexible member may act directly on the extensible member. However, additionally or alternatively, the position of the elongate flexible member may be used to control the degree of extension of the extensible member with some or all of the force to cause the change of length being provided from another source. For example, in the case of an object or device that is to be raised or lowered, the weight of the object may be used to lower it, with the elongate flexible member being used to oppose the weight in order to control its descent.

The provision of the elongate flexible member in a constraint means enables that member to transmit both tension and compression forces, in other words it may be used both to push and pull. The constraint means may be straight, but commonly it will contain bends to allow the force from the actuator to be directed as required. The constraint means may be a substantially rigid conduit.

In the case where the actuator of the invention is to be used to adjust the height of an object, the extensible member may be a support, for example an adjustable leg, which may conveniently be telescopic. The invention may be applied in this same manner to any telescopic member.

Thus, in a preferred form of the invention, the elongate flexible member is arranged to cause an adjustable support of an object to change its length. In the case of a telescopic leg, the elongate flexible member may act against a first telescoping part, whilst a second telescoping part is constrained, such that extension of the elongate flexible member causes the first telescoping part to extend from the second telescoping part.

The engagement of the elongate flexible member with the rotary member preferably comprises the former being wound around the latter. Thus, in a preferred form of the invention, when the rotary member rotates in a first direction about its axis the elongate flexible member winds around the rotary member and when the rotary member turns in a second direction about its axis the elongate flexible member unwinds from the rotary member, whereby as the proximal end of the elongate flexible member winds around the rotary member the distal end of the elongate flexible member is retracted, which may be used to cause the height of the object to be lowered, and as the proximal end of the elongate flexible member unwinds from the rotary member the distal end of the elongate flexible member is extended, which may be used to cause the height of the object to be raised.

The part of the actuator containing the rotary member may be provided separately from, and may be remote from, the object that is being raised. However, in preferred forms of the invention, the actuator and the member that is being extended are components of the same object. For example, the actuator may form part of a piece of furniture, or other apparatus, that is height-adjustable.

Thus, viewed from a third aspect, the present invention provides a height-adjustable object comprising an extensible member and a surface arranged to be raised and lowered by adjustment of that member and further comprising the actuator according to the first aspect of the invention, the actuator being arranged to adjust the height of the object. Thus, there may be provided a table comprising a table top, legs and an actuator as described above, whereby the height of the table may be adjusted by means of the actuator acting on the legs.

Any preferred features of the actuator of the first aspect can be included in the height-adjustable device of the second aspect of the present invention.

It will be appreciated that the maximum height adjustment is not limited by the size of the object being raised. For example, in the case of a table, the size of the tabletop does not significantly constrain the degree of height adjustment. The length of elongate flexible member which can wind and unwind from the rotary member dictates the maximum height change; however, the size of the rotary member and the length of the elongated flexible member can be determined during manufacture of the actuator to suit final end use requirements. The rotary member can be arranged to accommodate several turns of the elongate flexible member around it. Also the actuator can be more compact and less obtrusive as it does not need to span the whole width of the table being raised. In other words, the present invention provides an actuator which may have a small build-in width with potentially a very long stroke (distance between the maximum extension of the elongate flexible member and the minimum extension of the elongate flexible member).

The driving mechanism can be manually powered, for example comprising a handle for a user to turn, or electrically powered, when the driving mechanism may comprise an electric motor. Where the driving mechanism comprises an electric motor, this allows the user to raise and lower a device conveniently and with minimum effort. Additionally, the motor can be remotely controlled from a switching unit mounted some distance away so that the motor does not need to be readily accessible to the user. This means that the actuator can be compactly housed in a single housing underneath the device and does not need to protrude laterally from, or be near the edge of, a surface being raised. If a DC motor is used, the actuator may be controlled to operate in extension or retraction mode simply by changing the polarity of the current supplied to the motor.

There are a number of alternatives of drive train arrangements for transmitting the power to the rotary member. For example, the part of the driving mechanism providing power may be directly engaged with the rotary member or the driving mechanism may comprise a transmission between the source and the rotary member. There may be a gear box, at least one gear, a belt or chain or any working combination of these components to connect the power source to the rotary member. However, as discussed below, the transmission preferably comprises a worm drive.

In a preferred embodiment a braking means is provided to prevent the rotary member rotating when the driving mechanism is not driving the rotary member.

This prevents the length of the extensible member changing due to a weight or other force applied to it between height changing operations. The means could be a brake or clip provided on a leg of the device. However it is preferable for the braking system to be provided by the actuator itself as this can give a simpler and more compact device which is easier to manufacture. The braking means in the actuator may comprise a ratchet mechanism. However, more preferably a worm drive is used to transmit motion from the driving mechanism to the rotary member and to provide a braking means.

As is well known, with a worm drive a braking effect is achieved because a worm drive with a small enough pitch cannot be back-driven i.e. the worm can drive the worm gear but, because of the gear ratio, the worm gear cannot drive the worm. As a result when the worm is not driven the worm gear cannot rotate and thus the extension of the elongate flexible member cannot change. This ensures that the height of the device is maintained between height adjustment operations.

In the case of an actuator that is for use with a table or similar object, preferably the actuator should have a braking mechanism which is sufficient to prevent movement when the actuator is not being driven when a force of 1500 N is applied to the distal end of the elongate flexible member. More preferably, the braking mechanism should be able to withstand 2000 N. In the case of a worm drive, a worm gear with a pitch of 6 to 8 mm is sufficient to withstand 1500 to 2000 N. In a more preferred embodiment the braking means is a worm drive with a worm gear with a pitch of no more than 4 mm.

When the driving means comprises a worm drive it is preferable for the rotary member itself to comprise a worm gear. This again reduces the number of parts and makes the actuator simpler. Alternatively the rotary member could be attached to or engaged with the worm gear.

In a preferred embodiment a gear is provided on the end of the worm and preferably the gear is engaged with a driven gear. This arrangement provides a cheap and easy to manufacture drive train.

Where an electric motor is employed, it is preferable that the driven gear is mounted on the output shaft of the electric motor and drives the gear on the worm by means of a belt. However, the gear may be driven directly or by means of an intermediate gear, or a secondary worm gear arrangement may be employed.

In a preferred embodiment the actuator further comprises an end limit device, wherein the end limit device prevents the rotary member rotating about its axis more than a predetermined maximum amount in either direction. This is desirable as it can prevent the actuator or a member adjusted by it from being damaged by over-extension or over-retraction of the elongate flexible member. If the elongate member is over-extended the extensible member may be extended to a degree which causes damage to it or related components, for example by over-extending the legs of a table. Also, the elongate flexible member may become fully unwound from the rotary member.

Thus, preferably there is provided a device which prevents an over-extension or over-retraction of the elongate flexible member. Preferably such an “end limit” device allows the rotary member to rotate more than 360° but without risk of damaging the actuator or the device being raised or lowered.

This may be achieved by any mechanism which stops the rotary member turning past a predetermined maximum rotation in either direction. For example, the end limit device may be a static protrusion in engagement with the rotary member which stops the rotary member rotating past a certain point in either direction.

If the actuator is driven by an electric motor it is preferable to provide an end limit device which cuts the power to the motor once the rotary member reaches the predetermined maximum rotation in the direction it is being turned. This also prevents the motor from being overloaded.

Preferably the end limit device comprises an upper and a lower (or a first and a second) switch which when activated each stop the electric motor operating in a respective direction. With such an arrangement the upper switch can stop the motor operating to turn the rotary member in a first direction and the lower switch can stop the motor operating to turn the rotary member in a second direction. When the rotary member reaches a maximum rotation in the first direction the upper switch is activated and when the rotary member reaches a maximum rotation in the second direction the lower switch is activated.

Preferably the end limit device is arranged such that when the rotary member is being driven in one direction to a predetermined position, the switch which prevents the motor driving the rotary member any further in that direction is activated and when the rotary member is being driven in the opposite direction to another predetermined position the other switch is activated which prevents the motor driving the rotary member any further in that direction. Once the predetermined maximum rotation is reached the current to the motor is controlled to prevent any more rotation in that direction, but the motor can still operate in the other direction to cause rotation in the other direction.

In a preferred embodiment, the end limit device comprises an arm which follows a cam provided on the rotary member. Preferably the arm is provided on a pivot member which moves up and down as the arm moves up and down following the cam on the rotary member. Preferably when the rotary member is rotated a predetermined maximum amount in either direction the pivot member moves up or down a maximum amount to activate the upper or lower switch. This provides a small, simple and easy to manufacture device which prevents the rotary member being driven more than a maximum amount in either direction.

Preferably, when the end limit device comprises an arm which follows a cam on the rotary member, the end limit device comprises a spring which biases the arm to follow the path of the cam. The spring may be made of, for example, plastics or metal, with metal being preferred as it increases the working lifetime of the end limit device.

The rotary member is preferably generally toroidal and the end limit switch is preferably located in the center of the rotary member to minimize the size of the actuator.

The end limit switch of the preferred embodiment provides a simple, easy to manufacture and compact means to prevent the actuator causing over-extension or over-retraction of the elongate flexible member.

The elongate flexible member of the actuator can be any member which can follow a curved path whilst still transmitting a force along its length. It is therefore desirable for the elongate flexible member to be substantially incompressible. For example, the elongate flexible member may be a flexible hose, rod, etc with any cross section shape such as a circle, star, square or rectangle, but in a preferred embodiment the elongate flexible member comprises a spring. Preferably the thickness of the wire of the spring is equal to the pitch of the spring—i.e. it is a closed-coil spring—which means that adjacent turns of the spring will be in contact and thus the spring will be substantially incompressible.

The invention has been described so far in terms of the elongate flexible member passing through a constraint means. This means may be any suitable structure which prevents the elongate flexible member flexing or bowing out when a force is applied at one end. For example, the constraint may be a guide, or conduit with diameter slightly larger than the elongate flexible member or a cage through which the elongate flexible extends. The constraint means ensures that a force applied at one end of the elongate flexible member will be transferred to the other end of the elongate flexible member.

The actuator may comprise more than one rotary member with an elongate flexible member engaged with each rotary member. This means that a number of elongate flexible members can be used to adjust the height of an object. Thus, for example, each leg of a table may be adjusted simultaneously.

When the actuator comprises a plurality of rotary members it is preferable for the rotary members to be driven by the same driving mechanism. This facilitates the extension and retraction of the elongate flexible members by the same amount at the same time. Additionally, the actuator comprises fewer parts. When the actuator comprises more than one rotary member being driven by the same driving mechanism, the driving mechanism may comprise a single worm around which the multiple rotary members are arranged.

As discussed above, one preferred application of the present invention is to provide a height-adjustable object where height is adjustable by means of the actuator. The height-adjustable object can be any object which may need to be raised or lowered. For example it may be a table, chair, bed, hospital bed, treatment bed or any other item of furniture. The height of the object is preferably adjusted by the action of the actuator on telescopic leg(s).

Preferably, the height-adjustable device is a table having between one and four legs, although the table could have any number of legs. Also, each leg preferably has a corresponding elongate flexible member although more than one elongate flexible member could be associated with each leg.

In a preferred embodiment, the legs are substantially perpendicular to the surface of the device being raised. Although, when the table comprises a plurality of legs, the legs could be offset by a certain degree providing they still provide support for the table and allow the surface of the table to be raised and lowered by the actuator. The legs may all be offset from perpendicular by the same amount in the same or opposite direction or the legs may be offset by different amounts.

In a preferred embodiment, the elongate flexible member extends from the actuator through an extendible leg of the object to a reaction surface in the leg such that when the elongate flexible member is extended, the elongate flexible member is forced into the leg and the distal end of the elongate flexible member acts against the reaction surface which causes leg to extend and the object to rise. When the elongate flexible member is retracted it is pulled out of the leg which causes the surface (e.g. table top) of the height-adjustable device to lower. The object may lower due to its weight forcing the surface downward as the elongate flexible member is pulled out of the leg. Alternatively, the elongate flexible member may be attached to the reaction surface in the leg and as a result retracting the elongate flexible member would force the table top or other surface to lower by the action of the elongate flexible member pulling the reaction surface of the leg toward the surface of the object.

In a preferred embodiment, the leg(s) comprise(s) at least two portions which can telescopically slide within each other. The number of such portions can be more than two. When the number of telescopically slidable portions is two the maximum extension is just under double the height of one of the portions.

Viewed from a fourth aspect the present invention provides a method of adjusting the height of an object, the object comprising a surface to be raised or lowered and an actuator comprising a driving mechanism, a rotary member and an elongate flexible member, the method comprising: rotating the rotary member about its axis by means of the driving mechanism, wherein rotating the rotary member causes the elongate flexible member, which is connected to the rotary member, to wind around or unwind from the rotary member, thereby retracting the distal end of the elongate flexible member as the elongate flexible member winds around the rotary member causing the height of the surface of the device to be lowered and extending the distal end of the elongate flexible member as the elongate flexible member unwinds from the rotary member causing the height of the surface of the device to be raised.

Preferably the device comprises an end limit device and the method further comprises the end limit device preventing the rotary mechanism rotating about its axis more than a predetermined maximum amount in either direction. As described above this prevents the elongated flexible member being over-retracted or over-extended which may damage the actuator and/or the height-adjustable device.

The method according to the fourth aspect of the invention may include providing and using all the features of the first and second aspect of the invention.

### BRIEF DESCRIPTION OF THE DRAWING

Certain embodiments of the present invention will now be described, by way of example only, with reference to the accompanying drawings, in which:

FIG. 1 is a perspective view from above of a height-adjustable table according an embodiment of the invention;

FIG. 2 is a perspective view of the table of FIG. 1 from below;

FIG. 3 is an enlarged cut-away perspective view of the connection between the table's surface and one of its legs;

FIG. 4 is a perspective view of an actuator that forms part of the table of FIG. 1;

FIG. 5 is a perspective view of the actuator of FIG. 4 with the casing removed;

FIG. 6 is a perspective view of a section through of the actuator of FIG. 4;

FIG. 7 is a perspective view of a toroidal rotor of the actuator; and

FIG. 8 is an enlarged view of an end limit switch associated with the actuator.

### DETAILED DESCRIPTION

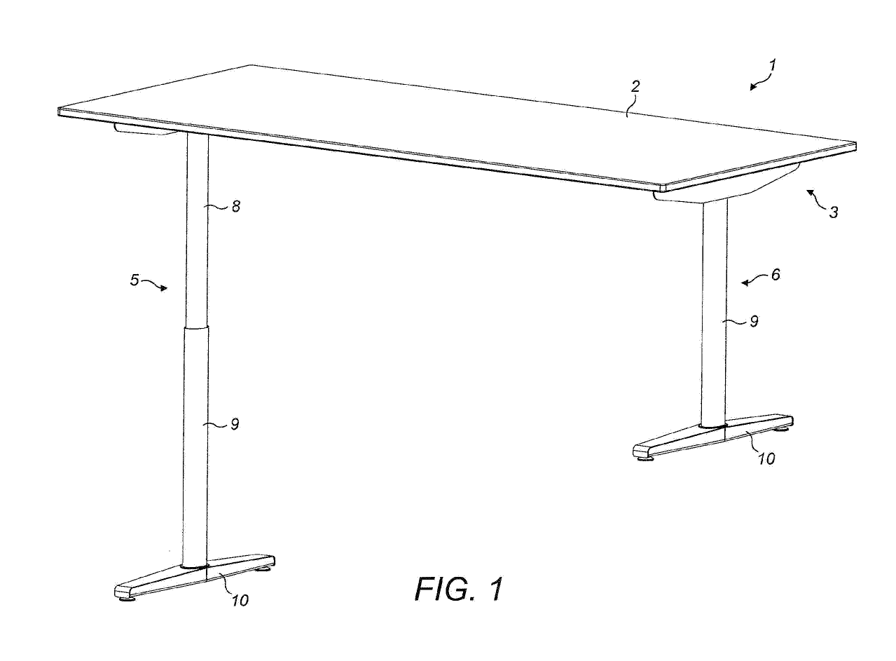

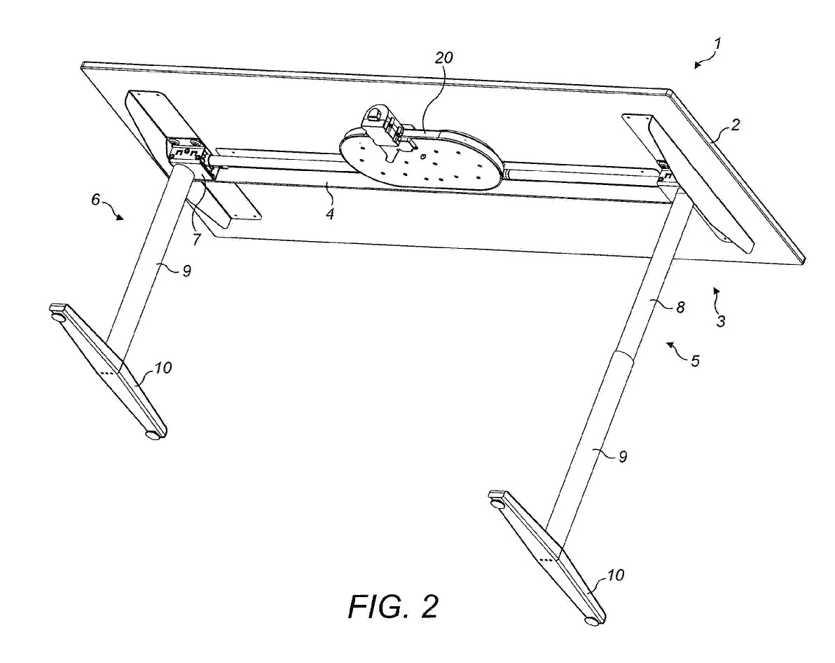

With reference to FIGS. 1 and 2, height-adjustable table 1 comprises a wood laminate tabletop 2 supported on a steel frame 3. Mounted on the frame beneath the tabletop 2 is an actuator 20 that will be discussed in detail below. The frame 3 has an H-shaped longitudinally extending support portion 4 attached by screws to the underside of the table top 2 and two legs 5, 6. Leg 5 is connected to a first end of the longitudinally extending portion 4 and leg 6 is connected to a second end of the support portion 4. Each of the legs 5, 6 extends perpendicularly to the plane of the tabletop 2.

Each leg 5, 6 is connected to the longitudinally extending support portion 4 of the frame 3 by means of connection portions 7 provided at opposite ends of support portion 4. The legs are each formed from two separate hollow tubular parts—an upper leg portion 8 and a lower leg portion 9—and a foot 10. The leg portions 8, 9 are arranged to slide telescopically within and over each other respectively in order to adjust the height of the table. The upper ends of the upper leg portions 8 are attached to a respective connecting portion 7. The bottom of each lower leg portion 9 is mounted to the center of foot 10 so that the foot extends laterally from the leg.

In FIGS. 1 and 2, one leg 6 is shown in a retracted position with the upper leg portion 8 received telescopically within the lower leg portion 9 so that the upper leg portion cannot be seen. The other leg 5 is shown in an extended position with only a portion of the upper leg portion 8 within the lower leg portion 9. In use, the legs will always be extended by the same amount i.e. the height of the legs would be equal; the legs are shown at different extensions in FIGS. 1 and 2 for the purposes of illustration only.

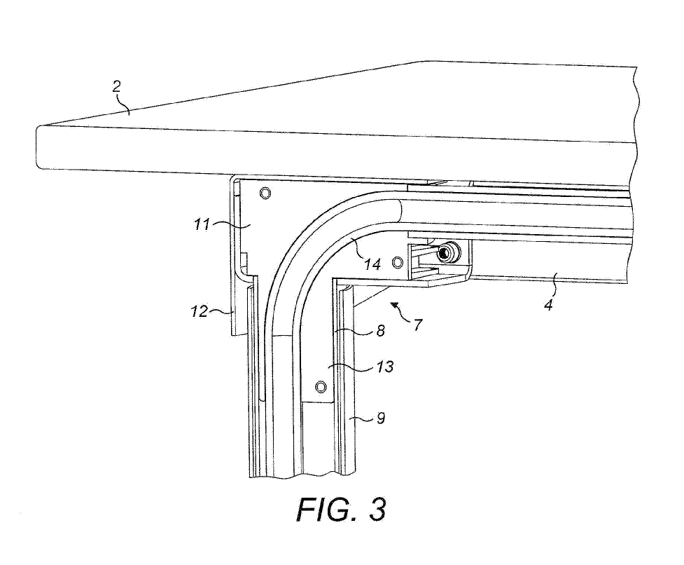

FIG. 3 shows in detail the attachment between one of the upper leg portions 8 and support portion 4 by means of a connection portion 7. The latter comprises a plastics molding 11, which is received within a housing 12 formed in the support portion. The molding 11 has a ribbed cylindrical projecting portion 13 which forms an interference fit within the top of the upper leg portion 8, thereby securing the leg to the support portion 4.

A curved passageway is provided through the molding 11 through which passes conduit 14. This extends from actuator 20 (from the right, as shown), along the inside of the support portion 4 and through the passageway into the leg.

As will be discussed further below, conduit 14 receives an elongate flexible closed-coil spring 24 (not shown in FIG. 3) which extends from the lower leg portion 9 to the actuator 20. The interior of conduit 14 has a low coefficient of friction to facilitate movement of the spring therethrough. The distal end of the spring engages with the lower leg portion such that extension of the spring within the conduit 14 will cause telescopic extension of the leg.

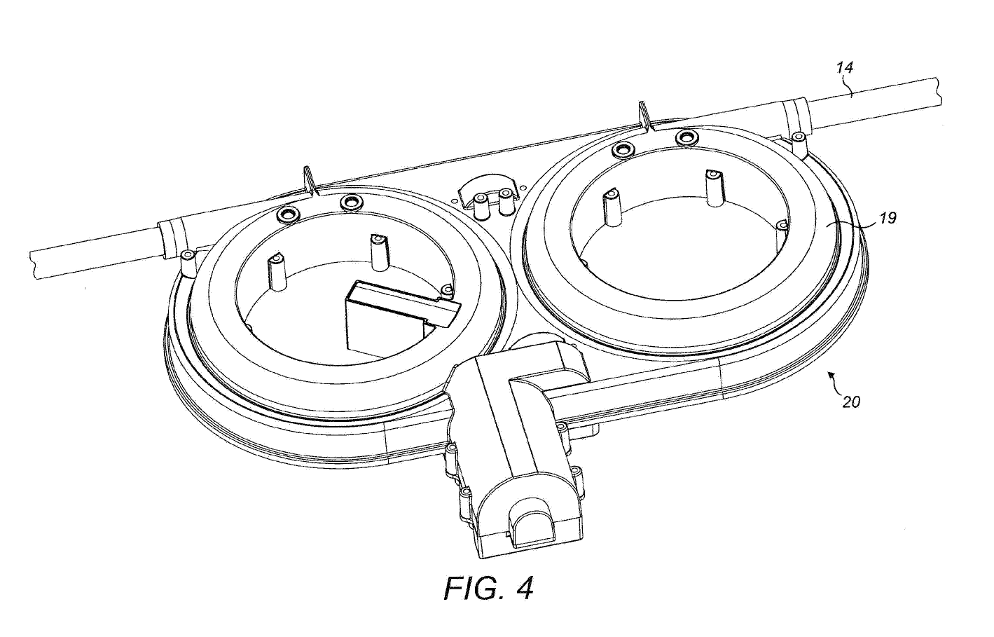

FIG. 4 is an enlarged view of the actuator 20 showing its housing 19 to which conduits 14 are connected. There can also be seen the part of the housing which contains an electric motor 21 and associated gears.

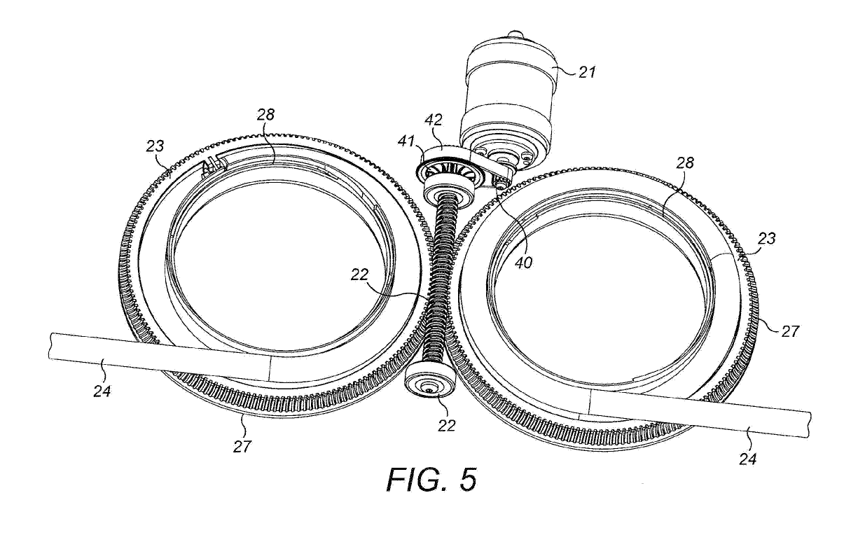

FIG. 5 shows an enlarged view of the internal components of the actuator 20. It may be seen that electric motor 21 and its associated gears and toothed belt are arranged to drive a pair of symmetrically arranged toroidal rotors 23 by means of a circumferential worm gear 27 formed at the lower part of each rotor. The drive train between the motor 21 and the worm gear 27 is provided by a driven gearwheel 40 on the output shaft of the motor 21 which is engaged with a gearwheel 41 on the worm 22 by means of a toothed belt 42. Gearwheel 41 is formed integrally with worm 22.

The rotors further comprise an integrally formed drum 28 which engages the spring 24 passing around it. It can be seen that the spring connected to the right toroidal rotor is more wound in than the spring on the left-hand toroidal rotor. This is shown for illustrative purposes only and in reality the springs will be wound around the drums 28 by equal amounts. Activating the motor causes the drums 28 to counter-rotate, thereby winding or unwinding the springs 24 around the drums 28. This has the effect that the springs 24 both extend or retract simultaneously and at the same rate in response to the drive provided by the motor 21.

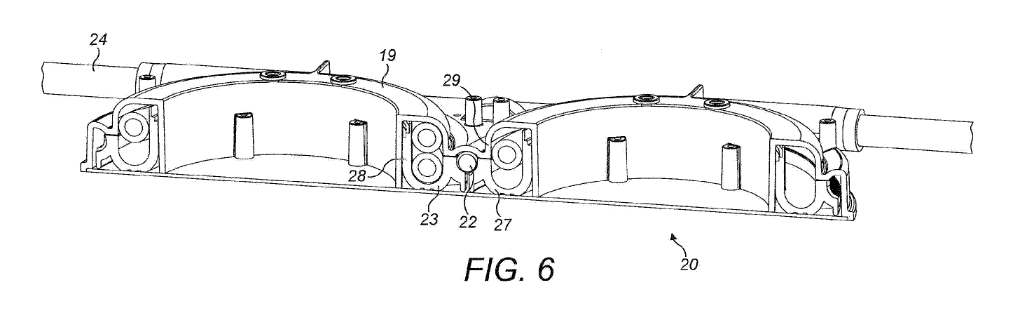

As may be seen from FIG. 6, the housing 19 is shaped to locate the rotors 23 and enable them to rotate freely as they are driven and to guide each spring from its conduit 14 around the respective drum 28. This is achieved by means of an inverted L-shaped housing member 29 which is provided between the top of the worm gear 27 and the top of the drum 28 and which constrains the radial position of the spring 24.

The pitch of the worm gear 27 is low enough to cause the device to be self-braking by means of the worm drive, i.e. a force applied on the spring 24 cannot turn the motor 21 and so the springs 24 remain in the position to which they are driven.

As discussed previously, each of the springs 24 is guided by conduit 14 from the actuator 20 to a leg 5, 6. Conduit 14 prevents the springs 24 from bowing out or kinking laterally or horizontally as it is unwound from the actuator so that force may be transmitted from the actuator to the table legs.

Within the leg 5, 6 the spring 24 is constrained by the leg itself and it extends to the lower leg portion 9 where it acts against a reaction surface (not shown) so that extension of the spring 24 causes the lower leg portion 9 to be pushed away from the upper leg portion 8, thereby extending the leg 5, 6 and raising the table. Retraction of the spring 24 likewise allows the table 1 to lower.

As each of the springs 24 are extended and retracted by the same amount as the actuator 20 operates, the two legs 5, 6 rise and fall by the same amount thereby ensuring that the tabletop remains horizontal.

It will be appreciated that the height of the table 1 may therefore be simply and conveniently controlled by switching the supply and polarity of current to the electric motor 21 in order to drive the motor 21 forward or reverse as desired. (The electrical supply and switch are not illustrated.)

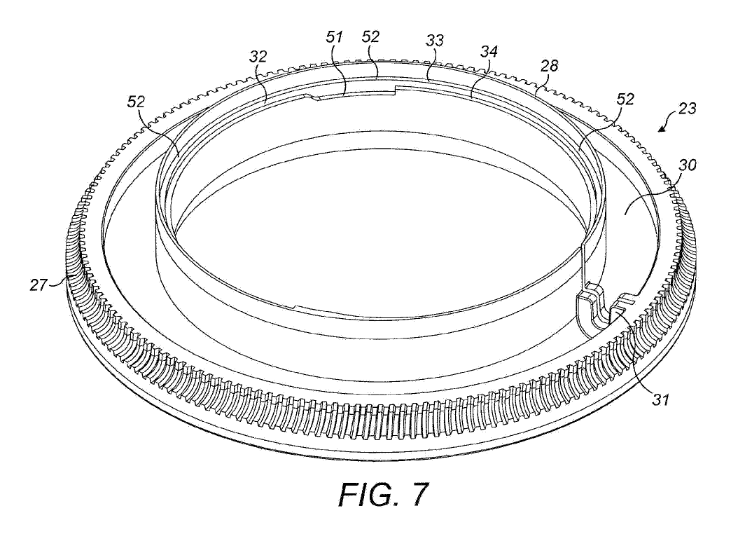

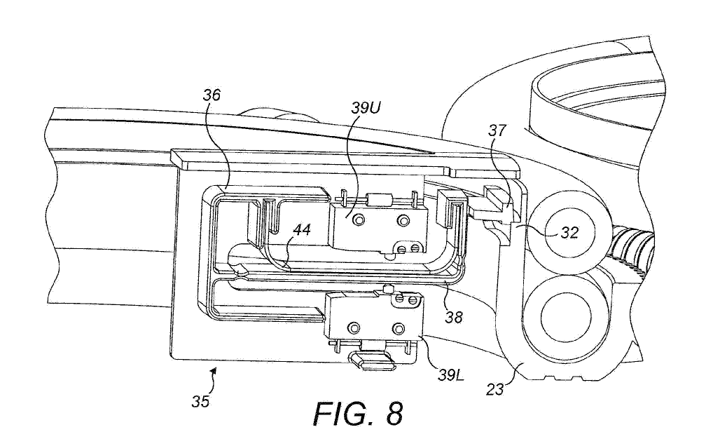

In order to prevent the actuator 20 over-extending or over-retracting the springs 24, which could damage the actuator 20, the actuator 20 is provided with an end limit system, as shown in FIGS. 7 and 8.

FIG. 7 shows a single toroidal rotor 23 in more detail. As described above, it comprises a drum 28 around which the proximal end of a spring 24 can be wound and a circumferential worm gear 27. Between the drum 28 and the worm gear 27 is a recess 30. Within the recess 30 is a spring connection member 31 to which the proximal end of the elongate spring 24 can attach to provide positive registration between the rotor 23 and the spring 24. The inner surface of the drum 30 is provided with a continuous spiral ridge 32 which forms a cam surface. It extends two turns around the inner surface thus forming an upper ridge portion 33 which is radially further from the center of the toroidal rotor 24 than a lower ridge portion 34.

FIG. 8 shows a limit switch assembly 35 which is located inside, and engages with, the cam surface formed by the ridge 32 one of the toroidal rotors 23. It is mounted to the housing 19 (not shown in FIG. 8) and therefore is held in a fixed location relative to the rotary motion of the toroidal rotor 23. (For the purpose of clarity the end limit switch is not shown in FIG. 5.) The end limit switch assembly 35 comprises an end limit switch holder 36, a cam following arm 37 and pivoting switch activator 38. The end limit switch holder 36 holds a lower microswitch 39L and an upper microswitch 39U and a biasing spring 44. The upper switch 39U is held in a position axially above the switch activator 38 and the lower switch 39L is held in a position axially below the switch activator 38. The spring 44 biases the arm 37 radially outwardly and axially downwardly so that the arm 37 follows the cam surface of ridge 32.

As the toroidal rotor 23 turns, the arm 37 follows the ridge as it spirals round the inside of the inner drum 28 which causes the arm 37 and switch activator 38 to axially rise or descend depending on the direction of rotation of the toroidal rotor 23.

The lower ridge portion 34 is provided with a groove 51 in a location determined to be aligned with the arm 37 when the toroidal rotor has reached its maximum travel one direction. The upper ridge portion 33 is provided with a number of holes 52. In one of the holes 52 is a pin (not shown). The location of the pin is determined to align with the arm 37 when the toroidal rotor 23 has rotated a predetermined maximum amount in the other direction. It will be appreciated that this arrangement allows the degree of travel of the rotor 23, and hence the springs 24 to be set to one of a number of alternatives, depending on where the pin is inserted.

When the table 1 is being lowered (i.e. the springs 24 are being wound around the toroidal rotor 23) the arm 37 follows the ridge 32 which is spiraling downward, as a result the arm 37 and with it the switch activator 38 descends, which brings the switch activator toward to the lower microswitch 39L. When the arm 37 reaches groove 51, the switch activator 38 descends to a position at which it activates the lower microswitch 39L. Activating the lower microswitch 39L prevents the motor 21 turning any further in that direction. However, the motor 21 can still be driven in the opposite direction. If this is done, as the table 1 rises, once arm 37 is out of the groove 51, the switch activator 38 will have moved away from the switch 39L thereby allowing the motor 21 to be driven again in the original direction, if desired.

If the motor 21 continues to move in the direction to raise the table 1, eventually the arm 37 will reach the pin which is located in one of the holes 52. At this point the table 1 will have reached its maximum height and arm 37, following ridge 32 will have risen to bring switch activator 38 into contact with upper microswitch 39U, which it will activate. This prevents the motor 21 turning any further in that direction and so the motor 21 can only be operated to cause the table 1 to lower and thus move the arm 43 off the pin.

It will be appreciated that at the predetermined maximum rotation in either direction, the groove or pin provides a step change in the profile of the ridge 32 to cause a step movement in the switch activator 38 to activate the microswitch suddenly in order to prevent arcing of the switch contacts.

In the embodiment shown in the Figures, the actuator has a built-in length (length of the housing containing the two rotary members) of 0.45 m and has a stroke (distance between the maximum extension and minimum extension) of 0.8 m for each of the elongate flexible members (i.e. a stroke of 2 times 0.8 m).

The process of lowering and then raising the table 1 will now be described. Initially the table 1 is in its fully raised position with only a comparatively small part of the upper leg 8 located within the lower leg 9, and thus the two springs 24 are wound out to a maximum amount from the drums 28 on toroidal rotors 23. This means that a maximum length of each spring 24 is in each leg 5, 6. The spring 24 is substantially incompressible and the actuator 20 is locked by means of the worm drive. As a result each spring 24 holds the legs 5, 6 in their telescopically extended configuration and hence holds the table 1 at its maximum height. In this configuration, the limit switch assembly 35 prevents the motor 21 from being actuated to raise the table 1 further, as described above.

To lower the table 1, the motor 21 is activated to drive the output shaft in the appropriate direction. As previously described, this turns the toroidal rotors 23 and causes each of the springs 24 to be wound inward. This action causes each of the springs 24 to be retracted out of the legs 5, 6 so that the upper leg portion 8 telescopically slides further into the lower leg portion 9, thereby lowering the height of the table 1. This continues either until the user determines that the table 1 is at the desired lower position or when the motor 21 is de-activated in the manner described above by the limit switch assembly 35. When the table 1 is in its minimum height configuration, the majority of each of the upper leg portions 8 is within the corresponding lower leg portion 9.

In order to raise the height of the table 1, the motor 21 is activated in the opposite direction. This causes each of the springs 24 to be wound out from the inner drum 28 of each toroidal rotor 23 which forces the springs 24 to extend in the leg 5, 6 by an equal amount on each side. This action creates a force against the reaction surface in the lower leg portion 9 which causes the table to rise. The tabletop 2 rises until the desired height is reached or the limit switch assembly 35 prevents the maximum height from being exceeded.

1. An actuator for adjusting the length of a stretchable member, the actuator comprising:
drive means;
a rotary member arranged to be driven about its axis by the drive means selectively in a first direction and a second direction; and
an elongate flexible member supported by a constraint means for transmitting force from the actuator to the stretchable member in order to adjust the length thereof; the elongate flexible member passing around and being engaged with the rotary member such that rotation of the rotary member in the first direction stretches and extends the elongate flexible member and rotation in the second direction relaxes and shortens the elongate flexible member.

2. The actuator as claimed in claim 1, wherein the elongate flexible member is arranged to act directly on the stretchable member to provide the force to cause it to extend and shorten.

3. The actuator as claimed in claim 1, the actuator being configured to adjust the height of an object supported by the stretchable member.

4. The actuator as claimed in claim 1, wherein when the rotary member rotates in a first direction about its axis the elongate flexible member winds around the rotary member and when the rotary member turns in a second direction about its axis the elongate flexible member unwinds from the rotary member such that as the elongate flexible member winds around the rotary member the distal end of the elongate flexible member is retracted to cause the length of the stretchable member to be reduced and as the elongate flexible member unwinds from the rotary member the distal end of the elongate flexible member is extended to cause the length of the stretchable member to be increased.

5. The actuator as claimed in claim 1, further comprising:
braking means to prevent the rotary member rotating when the drive means is not driving the rotary member.

6. The actuator as claimed in claim 5, wherein the driving means and the braking means comprise a worm gear in meshing relationship with a worm.

7. The actuator as claimed in claim 6, wherein the rotary member comprises the worm gear.

8. The actuator as claimed in claim 6, wherein a gear is provided on the end of the worm and wherein the gear is engaged with a driven gear by a toothed belt.

9. The actuator as claimed in claim 1, wherein the driven gear is driven by an electric motor.

10. The actuator as claimed in claim 9, wherein the driven gear is mounted on the output shaft of the electric motor.

11. The actuator as claimed in claim 1, wherein the actuator comprises an end limit device that prevents the rotary member from rotating about its axis more than a predetermined maximum amount in either direction.

12. The actuator as claimed in claim 11, wherein the end limit device comprises a first and a second switch each of which when activated stop the electric motor operating in a respective direction.

13. The actuator as claimed in claim 11, wherein the end limit switch comprises an arm which follows a cam provided on the rotary member.

14. The actuator as claimed in claim 13 wherein the arm is provided on a pivot member which moves up and down as the arm moves up and down following the cam on the rotary member such that when the rotary member is rotated a predetermined maximum amount in either direction the pivot member moves up or down a maximum amount to activate the upper or lower switch.

15. The actuator as claimed in claim 1, wherein the flexible member comprises a spring.

16. The actuator as claimed in claim 15, wherein the spring has a pitch equal to its wire thickness.

17. The actuator as claimed in claim 1, wherein there is a plurality of the rotary members and respective elongate flexible member connected to each rotary member.

18. The actuator as claimed in claim 17, wherein the plurality of rotary members are driven by the same drive means.

19. A height-adjustable object in combination with the actuator of claim 1 and comprising an the stretchable member and a surface arranged to be raised and lowered by adjustment of the stretchable member.

20. The height-adjustable object as claimed in claim 19, wherein the object has at least one leg and the elongate flexible member extends from the actuator through the leg of the object to a reaction surface in the leg.

21. The height-adjustable object as claimed in claim 20, wherein the leg comprises at least two portions which can telescopically slide within each other.

22. The height-adjustable object as claimed in claim 19, wherein the height-adjustable object is a table.

23. (canceled)

24. A method of adjusting the height of a object, the object comprising a surface to be raised or lowered and an actuator comprising a drive means, a rotary member and an elongate flexible member, the method comprising
rotating the rotary member about its axis by means of the drive means, wherein rotating the rotary member causes the elongate flexible member, which is connected to the rotary member to wind around or unwind from the rotary member, thereby retracting the distal end of the elongate flexible member as the elongate flexible member winds around the rotary member causing the height of the surface of the object to be lowered and extending the distal end of the elongate flexible member as the elongate flexible member unwinds from the rotary member causing the height of the surface of the object to be raised.

25. The method as claimed in claim 24, wherein the actuator comprises an end limit device, the method further comprising the actuator preventing the rotating mechanism rotating about its axis any more than a predetermined maximum amount in either direction.

26-29. (canceled)
